(19) United States
(12) Patent Application Publication
(10) Pub. No.: US 2026/0110146 A1
(43) Pub. Date: Apr. 23, 2026

(54) MILLING MACHINE VIBRATION REDUCTION

(71) Applicant: Caterpillar Paving Products Inc., Brooklyn Park, MN (US)

(72) Inventors: Daniel HEIM, Blaine, MN (US); Jason William MUIR, Andover, MN (US); Dustin W. SONDREAL, Saint Michael, MN (US)

(73) Assignee: Caterpillar Paving Products Inc., Brooklyn Park, MN (US)

(21) Appl. No.: 18/920,196

(22) Filed: Oct. 18, 2024

(51) Int. Cl. E01C 23/088; E01C 23/12; F16F 15/00; F16F 15/02

(52) U.S. Cl. CPC E01C 23/088; E01C 23/127; F16F 15/002; F16F 15/02; F16F 2222/126; F16F 2230/18

(57) ABSTRACT

A rotor lift assembly for a milling machine includes a first rotor lift arm, a second rotor lift arm, a cross tube, and one or more vibration reduction components. A first end of the cross tube is connected to the first rotor lift arm. A second end of the cross tube is connected to the second rotor lift arm. The one or more vibration reduction components are connected to the cross tube. The one or more vibration reduction components may be disposed within an interior of the cross tube. A first end of the cross tube may be connected to a first rotor lift arm via a first set of one or more vibration reduction components, and a second end of the cross tube may be connected to a second rotor lift arm via a second set of one or more vibration reduction components.

### TECHNICAL FIELD

The present disclosure relates generally to a milling machine and, for example, to milling machine vibration reduction.

### BACKGROUND

A milling machine can include a cold planer, a rotary mixer, or a reclaimer. Typically, during a milling operation, a rotor of the milling machine is used to engage a hardened asphalt, concrete, or other material of a surface of a paved area to remove one or more layers (e.g., at least a top layer) of the surface of the paved area. For example, a rotor lift assembly of the milling machine lowers to allow the rotor to rotate about an axis to cause teeth (or other cutting implements) of the rotor to cut into and break up the surface of the paved area. Often, due to a hardness of the surface of the paved area and the rotational force at which the rotor engages the surface, vibrations are produced that can propagate to, and thereby impact a performance of, the rotor, the rotor lift assembly, and one or more other components of the milling machine.

U.S. Patent No. 6,033,031 (“the ’031 patent”) discloses a milling machine that includes a frame, a drive mechanism for advancing the machine across a surface to be milled, and a milling assembly mounted on the frame of the machine for cutting a width of material from the surface in the path of the machine. According to the ’031 patent, the milling assembly also includes a vibratory assembly which is mounted so as to impart vibration to the milling drum. While the ’031 patent describes a vibration isolator for isolating the vibratory assembly so as to limit the transmission of vibration created thereby to the frame of the machine, the ’031 patent concerns vibration that is purposefully created by the vibratory assembly and limiting transmission of that vibration to the frame of the milling machine (and not to other components of the milling machine).

The milling machine, and the rotor lift assembly of the milling machine, of the present disclosure solves one or more of the problems set forth above and/or other problems in the art.

### SUMMARY

In some implementations, a rotor lift assembly for a milling machine includes a first rotor lift arm; a second rotor lift arm; a cross tube; and one or more vibration reduction components, wherein: a first end of the cross tube is connected to the first rotor lift arm; a second end of the cross tube is connected to the second rotor lift arm; and the one or more vibration reduction components are connected to the cross tube.

In some implementations, a milling machine includes a rotor lift assembly comprising: a cross tube, and one or more vibration reduction components, wherein: a first end of the cross tube is connected to a first rotor lift arm of the rotor lift assembly; a second end of the cross tube is connected to a second rotor lift arm of the rotor lift assembly; and the one or more vibration reduction components are connected to the cross tube.

In some implementations, a milling machine includes a cross tube of a rotor lift assembly of the milling machine; and one or more vibration reduction components that are connected to the cross tube.

### BRIEF DESCRIPTION OF THE DRAWINGS

FIG. 1 is a diagram of an example machine described herein.

FIGS. 2A-2F show examples of a rotor lift assembly of the machine.

FIGS. 3A-3B show examples of the rotor lift assembly.

FIG. 4 shows an example of the machine described herein.

FIG. 5 is a diagram of example components of a device associated with milling machine vibration reduction.

FIG. 6 is a flowchart of an example process associated with milling machine vibration reduction.

### DETAILED DESCRIPTION

This disclosure relates to a rotor lift assembly, which is applicable to any machine that utilizes a rotor lift assembly, such as a machine that utilizes a rotor (e.g., to perform a milling operation).

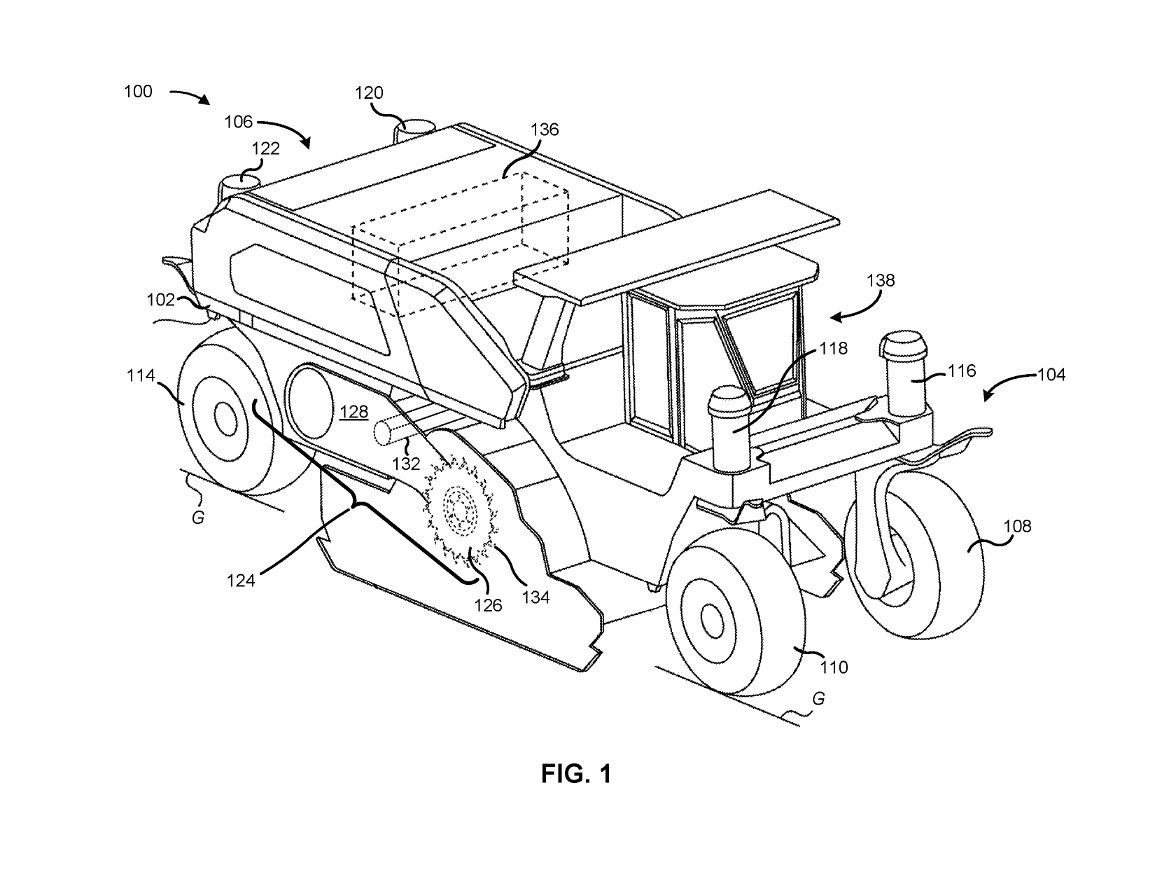

FIG. 1 is a diagram of an example machine 100 described herein. The machine 100 may be a cold planer, a rotary mixer, a reclaimer, or another type of milling machine, which may be used to perform a milling operation. While in FIG. 1 the machine 100 is depicted as a milling machine, the machine 100 may be another type of machine.

The machine 100 may include a frame 102, which may extend from a first end 104 to a second end 106 disposed opposite the first end 104. In some implementations, the first end 104 may be a front end and the second end 106 may be a rear end of the frame 102.

The frame 102 may be supported on one or more propulsion devices 108, 110, 112 (not visible in FIG. 1), 114, which may be wheels. The propulsion devices 108, 110, 112, 114 may be equipped with electric or hydraulic motors which may impart motion to the propulsion devices 108, 110, 112, 114 to help propel the machine 100 in a forward or rearward direction. The propulsion devices 108, 110, 112, 114 may take the form of tracks, which may include, for example, sprocket wheels, idler wheels, and/or one or more rollers that may support a continuous track. As further shown in FIG. 1, the frame 102 may be connected to the propulsion devices 108, 110, 112, 114 by one or more legs 116, 118, 120, 122 (respectively).

The machine 100 may include a rotor lift assembly 124, which may be located between the first end 104 and the second end 106. The rotor lift assembly 124 may include a rotor 126, a first rotor lift arm 128, a second rotor lift arm 130 (not visible in FIG. 1), and/or a cross tube 132. The rotor 126 may be a device that is configured to rotate (e.g., about an axis of the rotor 126) within the frame 102 to break up a ground surface G during a milling operation. For example, the rotor 126, which may include a plurality of teeth 134 (or other cutting implements) to penetrate the ground surface G, may be a universal rotor, a combination rotor, a soil rotor, a spade rotor, or another type of rotor. The rotor 126 may be attached to the frame 102 via the first rotor lift arm 128 and the second rotor lift arm 130, which may be disposed on either side (e.g., a right side and a left side, respectively) of the machine 100. As also illustrated in FIG. 1, the first rotor lift arm 128 and the second rotor lift arm 130 may extend from the frame 102 toward the first end 104 of the frame 102, but, in some implementations, the first rotor lift arm 128 and the second rotor lift arm 130 may extend from the frame 102 toward the second end 106 of the frame 102. A first end of the cross tube may be connected to the first rotor lift arm 128, and a second end of the cross tube may be connected to the second rotor lift arm 130, such as to allow the first rotor lift arm 128 and the second rotor lift arm 130 to lower or raise the rotor 126 (e.g., to or from the ground surface G) in tandem. The rotor 126 may be attached to free ends of the first rotor lift arm 128 and the second rotor lift arm 130. Examples of the rotor lift assembly 124 are further described herein.

The machine 100 may include an engine 136. The engine 136 may include any type of engine (e.g., internal combustion, gas, diesel, gaseous fuel, natural gas, propane, or the like) or an electric motor. The engine 136 may be configured to deliver rotational power output to one or more hydraulic motors associated with the propulsion devices 108, 110, 112, 114 and to the rotor 126. The engine 136 may also be configured to deliver power to operate one or more other components or accessory devices (e.g. pumps, fans, motors, generators, belt drives, transmission devices, or the like) associated with the machine 100.

The machine 100 may include an operator platform 138, which may be attached to the frame 102. The operator platform 138 may be in the form of an open-air platform that may or may not include a canopy, or a partially or fully enclosed cabin. The operator platform 138 may include one or more control or input devices that may be used by an operator of the machine 100 to control operations of the machine 100.

As indicated above, FIG. 1 is provided as an example. Other examples may differ from what is described in connection with FIG. 1.

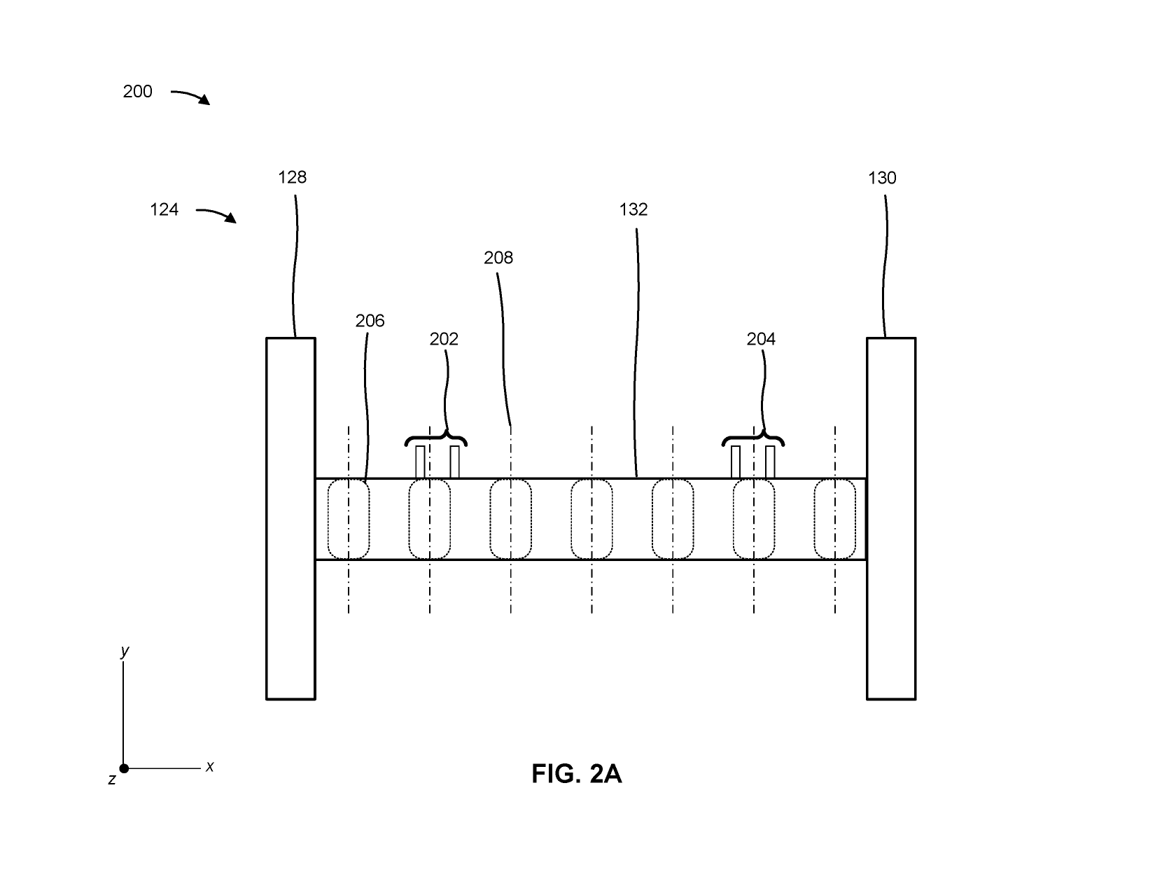

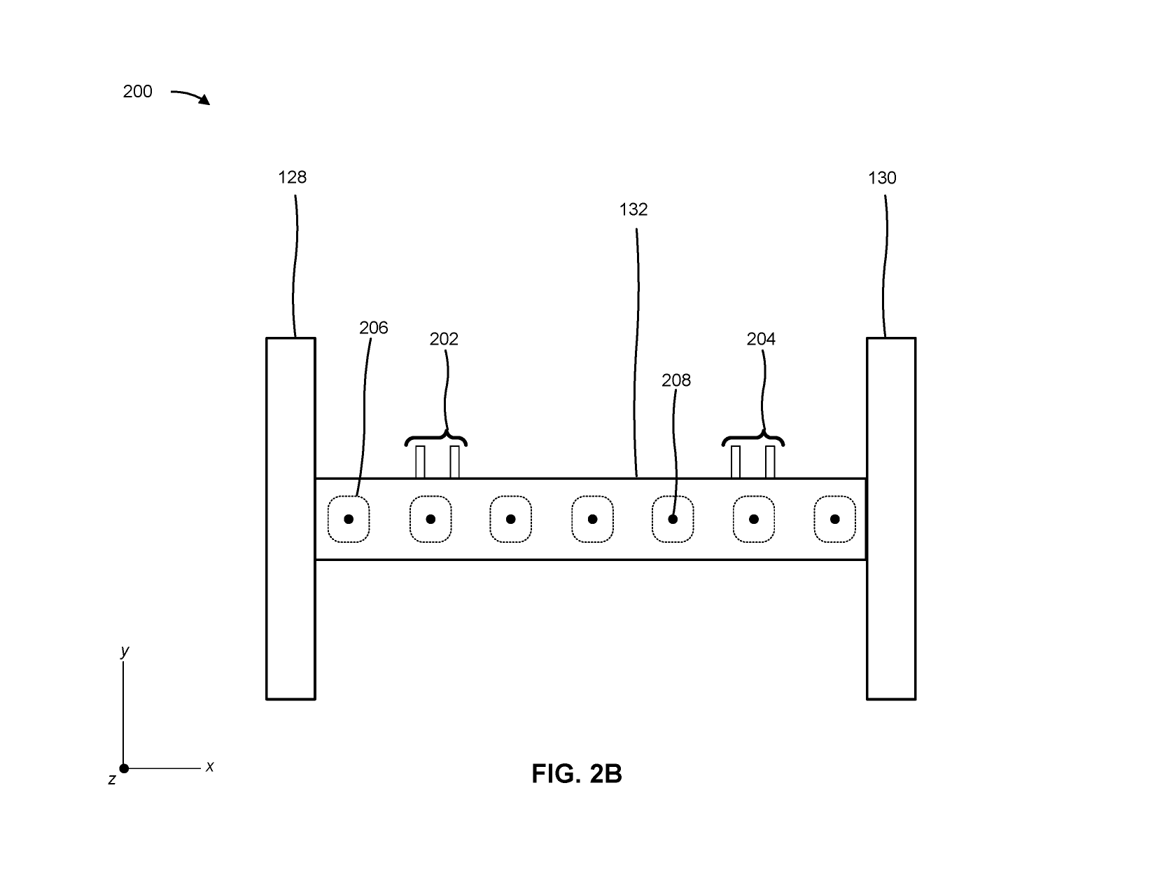

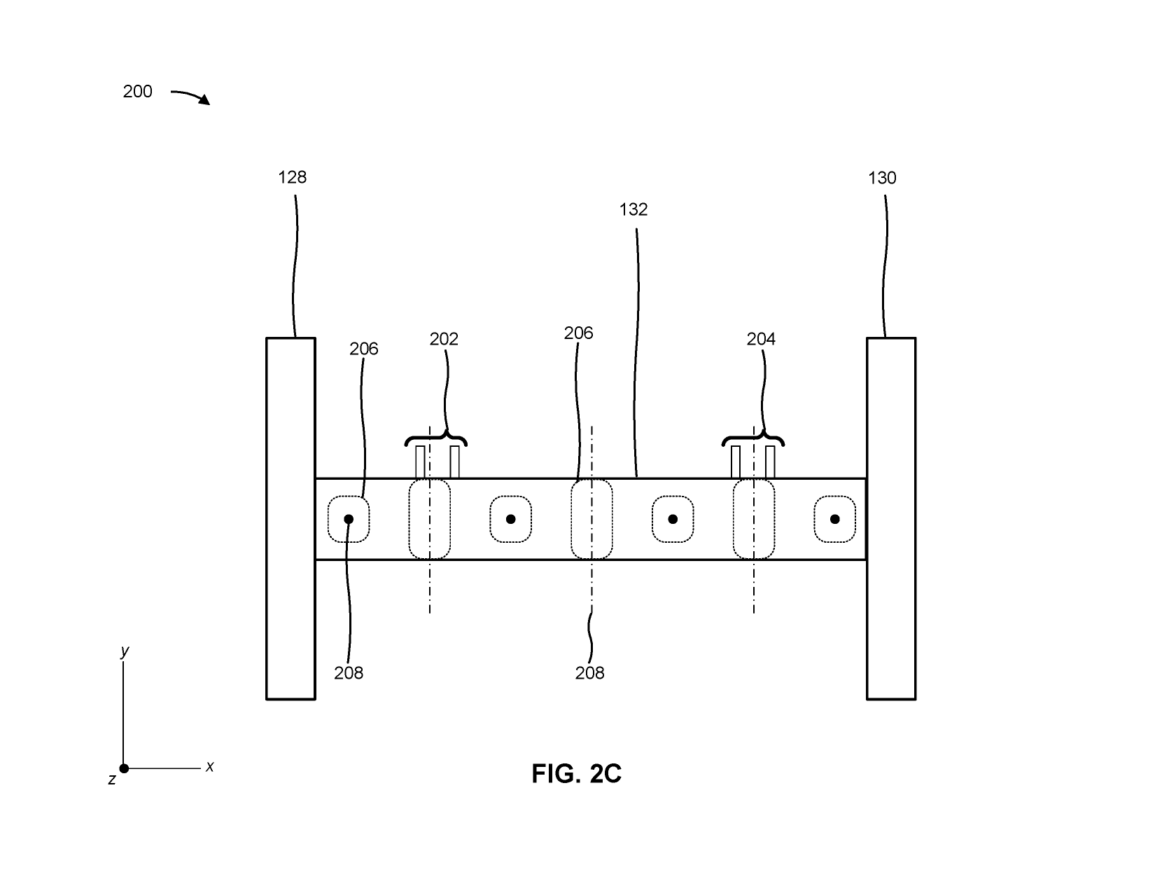

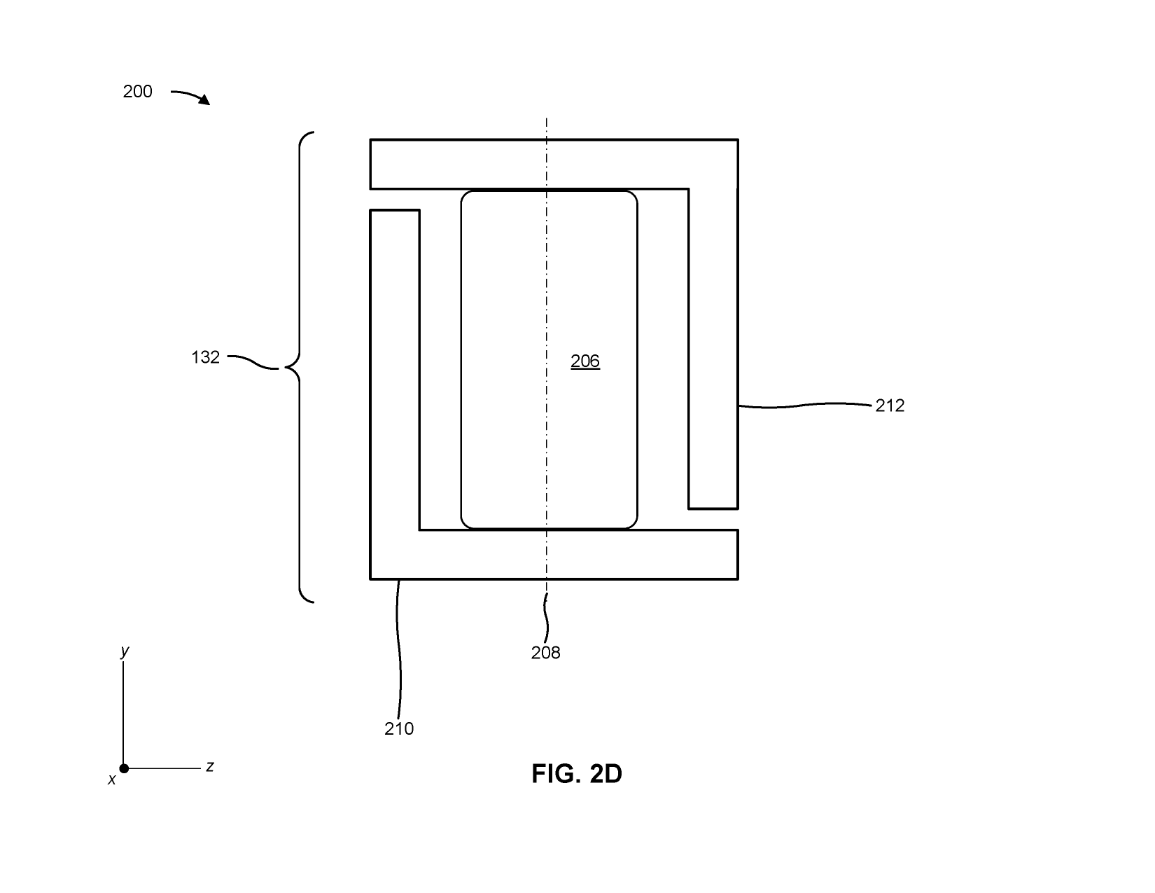

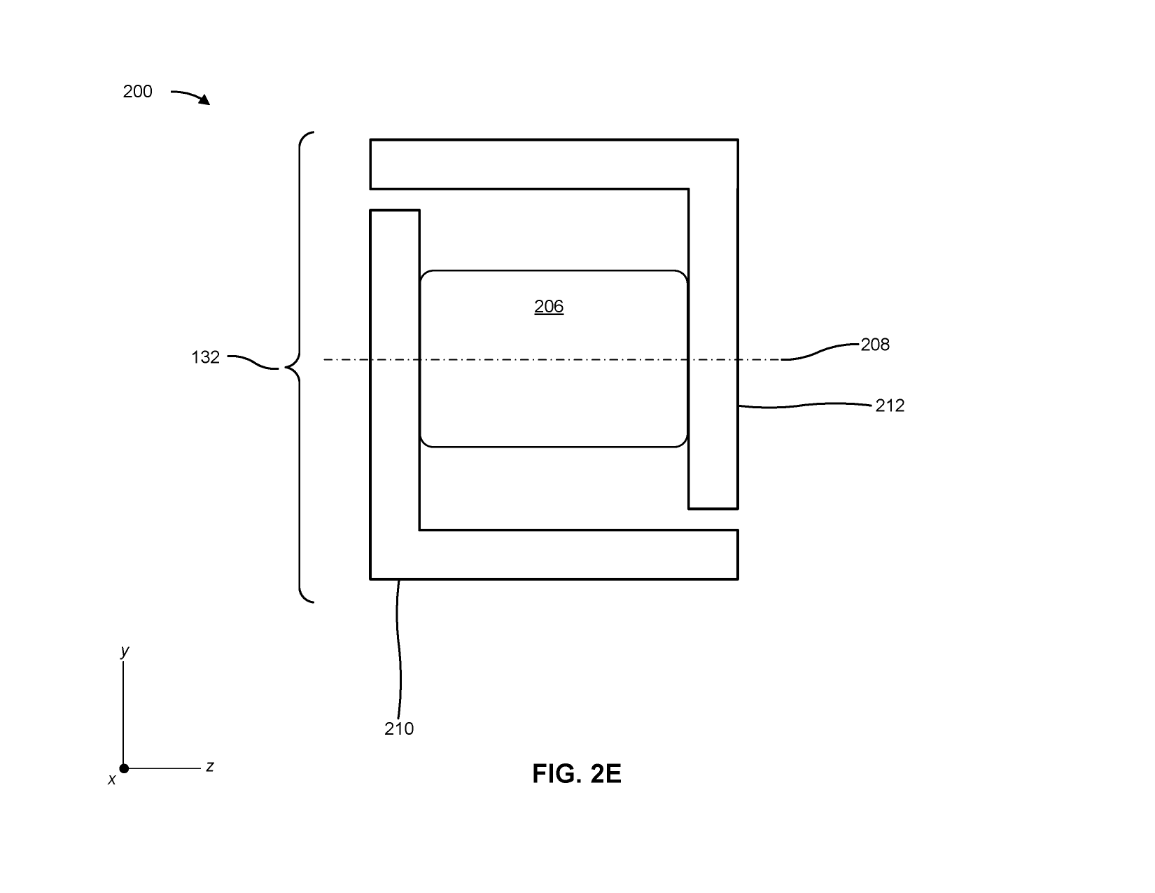

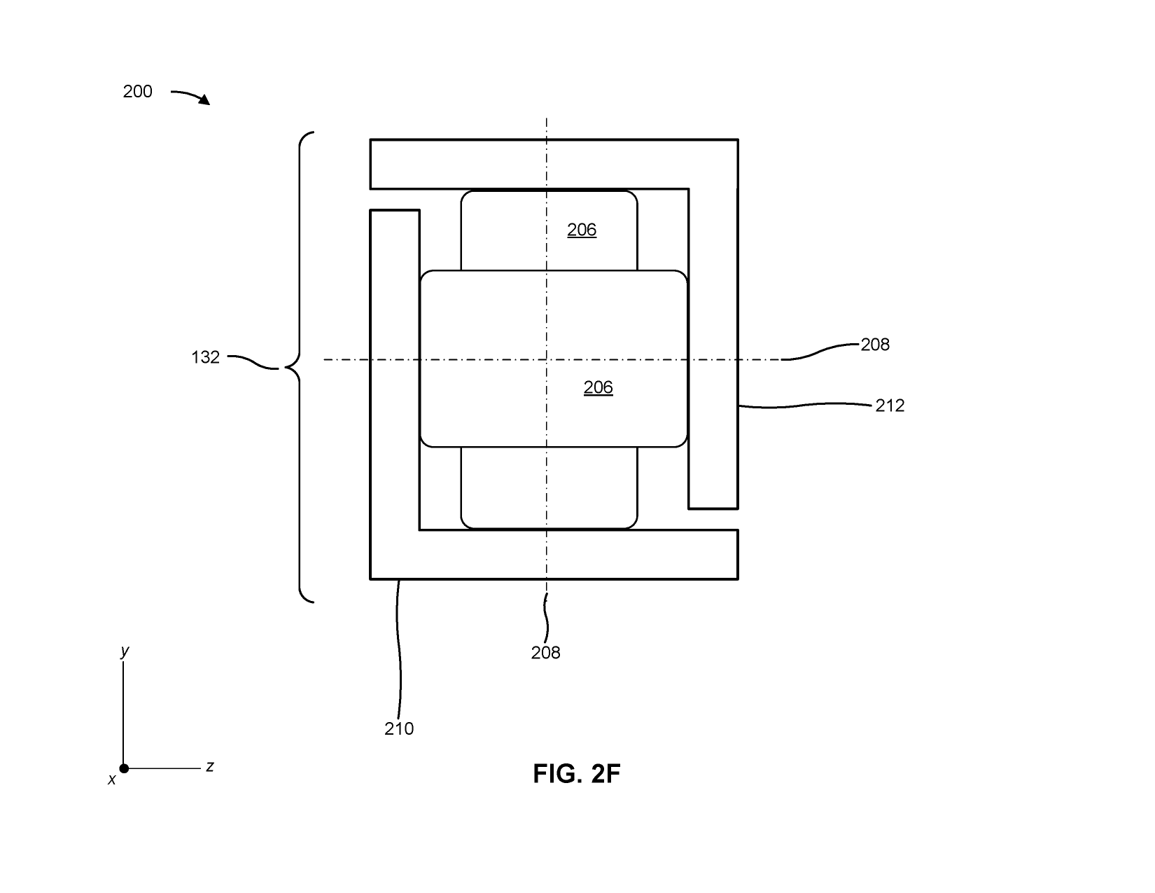

FIGS. 2A-2F show examples 200 of the rotor lift assembly 124. FIGS. 2A-2C show frontal views of the rotor lift assembly 124, where a height of the rotor lift assembly 124 is aligned with a y-axis of a coordinate system, a width of the rotor lift assembly 124 is aligned with an x-axis of the coordinate system, and a length of the rotor lift assembly 124 is aligned with a z-axis of the coordinate system.

As shown in FIGS. 2A-2C, the rotor lift assembly 124 may include the first rotor lift arm 128, the second rotor lift arm 130, and the cross tube 132, as described herein in relation to FIG. 1. For example, as further shown in FIGS. 2A-2C, a first end of the cross tube 132 may be connected (e.g., using one or more bolts, or other attachment components) to the first rotor lift arm 128, and a second end of the cross tube 132 may be connected (e.g., using one or more bolts or other attachment components) to the second rotor lift arm 130.

As further shown in FIGS. 2A-2C, the rotor lift assembly 124 may include one or more lifting components 202, 204 that are connected to the cross tube 132. The one or more lifting components 202, 204 may be configured to connect to one or more actuators (e.g., one or more hydraulic actuators, or other types of actuators), respectively. The one or more actuators may be configured to raise and lower the cross tube 132 to thereby enable raising and lowering of the first rotor lift arm 128 and the second rotor lift arm 130 (e.g., in tandem, because the first rotor lift arm 128 and the second rotor lift arm 130 are connected to the cross tube 132). This further enables lowering or raising of the rotor 126 (not shown in FIGS. 2A-2C) (e.g., as described herein in relation to FIG. 1, such as to facilitate a milling operation of the machine 100). The one or more lifting components 202, 204 may be individual components that are attached to (e.g., mounted on) respective regions of the cross tube 132, or, alternatively, may be integrated components of the cross tube 132.

As further shown in FIGS. 2A-2C, the rotor lift assembly 124 may include one or more vibration reduction components 206, which may be connected to the cross tube 132. Each vibration reduction component 206 may comprise, for example, at least one of an isolation mount (e.g., comprising a rubber material, and elastomeric material, or a similar type of material), an airbag (e.g., a pneumatic device configured to hold an amount of air), a hydraulic damper (e.g., a hydraulic device configured to dissipate energy via resistance), or a spring mount (e.g., that includes a spring, or another mechanical device, that is configured to absorb energy through compression or flexing). Each vibration reduction component 206 may have an orientation axis 208, which may be associated with one or more vibration reduction capabilities of the vibration reduction component 206. For example, each vibration reduction component 206 may have a greater vibration reduction capability for vibrations that propagate in a direction that is parallel to (e.g., within a tolerance of) the orientation axis 208 (e.g., as compared to a vibration reduction capability for vibrations that propagate in different directions).

In some implementations, the cross tube 132 may include an interior. That is, the cross tube 132 may comprise a hollow structure (e.g., a round or polygonal tube, beam, or other type of structure) that includes an interior (e.g., defined by interior surfaces of the hollow structure). Accordingly, as further shown in FIGS. 2A-2C, the one or more vibration reduction components 206 may be disposed within the interior of the cross tube 132 (and connected to one or more of the interior surfaces of the cross tube 132).

As shown in FIGS. 2A-2B, the one or more vibration reduction components 206 may be disposed within the interior of the cross tube 132 such that the respective orientation axes 208 of the one or more vibration reduction components 206 are aligned (e.g., are parallel to, within a tolerance, each other). For example, as shown in FIG. 2A, the respective orientation axes 208 of the one or more vibration reduction components 206 may be aligned with the y-axis of the coordinate system. As another example, as shown in FIG. 2B, the respective orientation axes 208 of the one or more vibration reduction components 206 may be aligned with the z-axis of the coordinate system. In this way, because the one or more vibration reduction components 206 are aligned, the one or more vibration reduction components 206 may provide one or more combined vibration reduction capabilities in a particular direction (e.g., that is aligned with the respective orientation axes 208 of the one or more vibration reduction components 206).

As shown in FIG. 2C, the one or more vibration reduction components 206 may be disposed within the interior of the cross tube 132 such that an orientation axis 208 of a first vibration reduction component 206, of the one or more vibration reduction components 206, is not aligned with an orientation axis 208 of a second vibration reduction component 206 of the one or more vibration reduction components 206. For example, the orientation axis 208 of the first vibration reduction component 206 may be aligned with the y-axis of the coordinate system, and the orientation axis 208 of the second vibration reduction component 206 may be aligned with the z-axis of the coordinate system. In this way, because the one or more vibration reduction components 206 are not all aligned, the one or more vibration reduction components 206 may provide one or more combined vibration reduction capabilities in more than one direction.

Accordingly, as shown by FIGS. 2A-2C, respective orientation axes 208 of at least two of the one or more vibration reduction components 206 may be aligned, and/or respective orientation axes 208 of at least two of the one or more vibration reduction components 206 may not be aligned. Thus, the one or more vibration reduction components 206 may be disposed within the interior of the cross tube 132 in a configuration that is to provide a particular vibration reduction performance (e.g., in one or more directions, in association with performance of a milling operation by the machine 100).

FIGS. 2D-2F show side, cut-away views of the cross tube 132 of the rotor assembly 124. FIG. 2D shows the one or more vibration reduction components 206 disposed within the interior of the cross tube 132 such that the respective orientation axes 208 of the one or more vibration reduction components are aligned with the y-axis of the coordinate system (e.g., as described herein in relation to FIG. 2A). FIG. 2E shows the one or more vibration reduction components 206 disposed within the interior of the cross tube 132 such that the respective orientation axes 208 of the one or more vibration reduction components are aligned with the z-axis of the coordinate system (e.g., as described herein in relation to FIG. 2B). FIG. 2F shows the one or more vibration reduction components 206 disposed within the interior of the cross tube 132 such that the respective orientation axes 208 of the one or more vibration reduction components are aligned with one of the y-axis or the z-axis of the coordinate system (e.g., as described herein in relation to FIG. 2C).

Notably, as shown in FIGS. 2D-2F, the cross tube 132 may comprise a first component 210 and a second component 212, wherein the first component 210 does not contact the second component 212, but the first component 210 is connected to the second component 212 via the one or more vibration reduction components 206 (e.g., within an interior of the cross tube 132 that is defined by the first component 210 and the second component 212). Accordingly, the one or more vibration reduction components 206 may reduce propagation of vibrations between the first component 210 and the second component 212 (e.g., with respect to the orientation axes of the one or more vibration reduction components 206), which facilitates the one or more vibration reduction components 206 providing a particular vibration reduction performance (e.g., in one or more directions, in association with performance of a milling operation by the machine 100 as described elsewhere herein). For example, any vibration that is to propagate between the first component 210 and the second component 212, needs to propagate via the one or more vibration reduction components 206 and is thereby reduced by the one or more vibration reduction components 206.

As indicated above, FIGS. 2A-2F are provided as an example. Other examples may differ from what is described in connection with FIGS. 2A-2F.

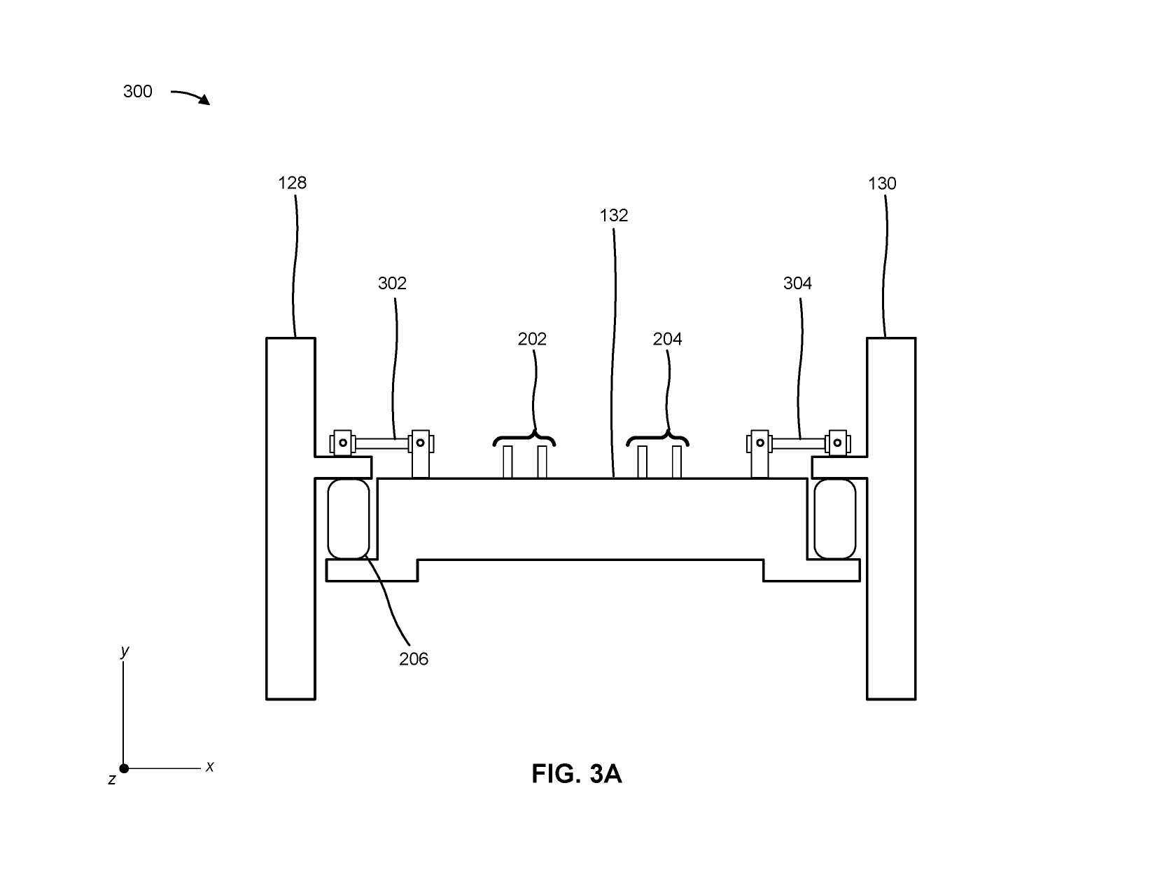

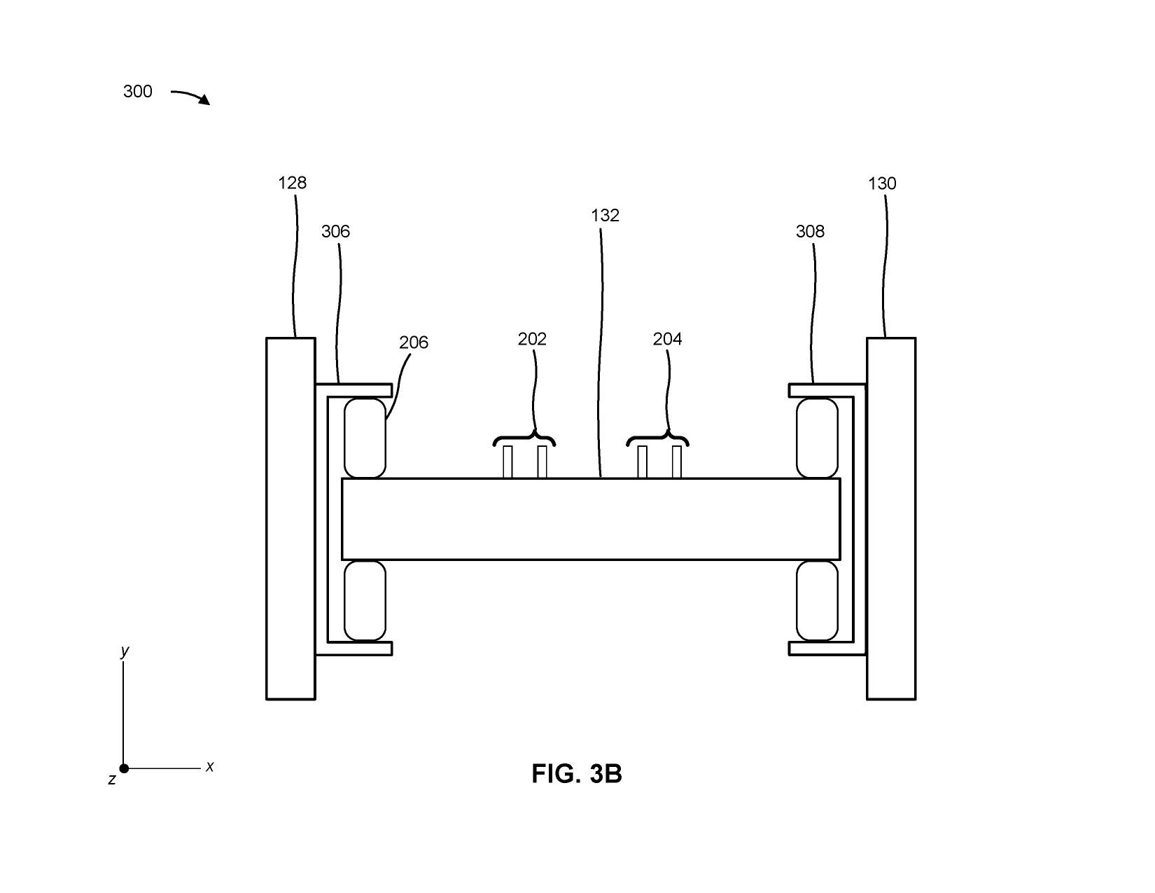

FIGS. 3A-3B show examples 300 of the rotor lift assembly 124. FIGS. 3A-3B show frontal views of the rotor lift assembly 124, where a height of the rotor lift assembly 124 is aligned with a y-axis of a coordinate system, a width of the rotor lift assembly 124 is aligned with an x-axis of the coordinate system, and a length of the rotor lift assembly 124 is aligned with a z-axis of the coordinate system.

As shown in FIGS. 3A-3B, the rotor lift assembly 124 may include the first rotor lift arm 128, the second rotor lift arm 130, and the cross tube 132, as described herein in relation to FIG. 1. The rotor lift assembly 124 may further include the one or more lifting components 202, 204 and/or include one or more vibration reduction components 206, as described in relation to FIGS. 2A-2C. The one or more vibration reduction components 206 may be connected to the cross tube 132, as further described herein.

As shown in FIG. 3A, the first end of the cross tube 132 may be connected to the first rotor lift arm 128 via a first connection component 302 of the rotor lift assembly 124, and the second end of the cross tube 132 may be connected to the second rotor lift arm 130 via a second connection component 304 of the rotor lift assembly 124. Each of the first connection component 302 and the second connection component 304 may include, for example, a turnbuckle, or another type of connection component.

As further shown in FIG. 3A, a first vibration reduction component 206 (e.g., a right vibration reduction component 206 of the rotor lift assembly 124, when viewed from the front), of the one or more vibration reduction components 206, may be connected to the first end of the cross tube 132 and to the first rotor lift arm 128. That is, the first vibration reduction component 206 may be disposed between the first end of the cross tube 132 and the first rotor lift arm 128, such as to reduce vibrations propagating from the cross tube 132 to the first rotor lift arm 128 and/or from the first rotor lift arm 128 to the cross tube 132. As additionally shown in FIG. 3A, a second vibration reduction component 206 (e.g., a left vibration reduction component 206 of the rotor lift assembly 124, when viewed from the front), of the one or more vibration reduction components 206, may be connected to the second end of the cross tube 132 and to the second rotor lift arm 130. That is, the second vibration reduction component 206 may be disposed between the second end of the cross tube 132 and the second rotor lift arm 130, such as to reduce vibrations propagating from the cross tube 132 to the second rotor lift arm 130 and/or from the second rotor lift arm 130 to the cross tube 132.

Accordingly, as shown in FIG. 3A, the cross tube 132 may not directly contact the first rotor lift arm 128 and the second rotor lift arm 130 (e.g., because the cross tube 132 is connected to the first rotor lift arm 128 via the first connection component 302 and the first vibration reduction component 206, and the cross tube 132 is connected to the second rotor lift arm 130 via the second connection component 304 and/or the second vibration reduction component 206). In this way, vibrations propagating from the cross tube 132 to the first rotor lift arm 128 and the second rotor lift arm 130 and/or from the first rotor lift arm 128 and the second rotor lift arm 130 to the cross tube 132 are further reduced.

As shown in FIG. 3B, a first set of one or more vibration reduction components 206, of the one or more vibration reduction components 206, may be connected to the first end of the cross tube 132 and to the first rotor lift arm 128 (e.g., without the first connection component 302). For example, the first rotor lift arm 128 may include a mounting component 306 (e.g., a bracket, or other type of component, that is attached to, or integrated into, the first rotor lift arm 128), where the first set of one or more vibration reduction components 206 are connected to respective regions of the mounting component 306 of the first rotor lift arm 128 and to respective regions of the first end of the cross tube 132. In this way, the first end of the cross tube 132 may be connected to the first rotor lift arm 128 via the first set of one or more vibration reduction components 206, such as to reduce vibrations propagating from the cross tube 132 to the first rotor lift arm 128 and/or from the first rotor lift arm 128 to the cross tube 132.

As further shown in FIG. 3B, a second set of one or more vibration reduction components 206, of the one or more vibration reduction components 206, may be connected to the second end of the cross tube 132 and to the second rotor lift arm 130 (e.g., without the second connection component 304). For example, the second rotor lift arm 130 may include a mounting component 308 (e.g., a bracket, or other type of component, that is attached to, or integrated into, the second rotor lift arm 130), where the second set of one or more vibration reduction components 206 are connected to respective regions of the mounting component 308 of the second rotor lift arm 130 and to respective regions of the second end of the cross tube 132. In this way, the second end of the cross tube 132 may be connected to the second rotor lift arm 130 via the second set of one or more vibration reduction components 206, such as to reduce vibrations propagating from the cross tube 132 to the second rotor lift arm 130 and/or from the second rotor lift arm 130 to the cross tube 132.

Accordingly, as shown in FIG. 3B, the cross tube 132 may not directly contact the first rotor lift arm 128 and the second rotor lift arm 130 (e.g., because the cross tube 132 is connected to the first rotor lift arm 128 via the first set of one or more vibration reduction components 206, and the cross tube 132 is connected to the second rotor lift arm 130 via the second set of one or more vibration reduction components 206). In this way, vibrations propagating from the cross tube 132 to the first rotor lift arm 128 and the second rotor lift arm 130 and/or from the first rotor lift arm 128 and the second rotor lift arm 130 to the cross tube 132 are reduced.

As indicated above, FIGS. 3A-3B are provided as an example. Other examples may differ from what is described in connection with FIGS. 3A-3B.

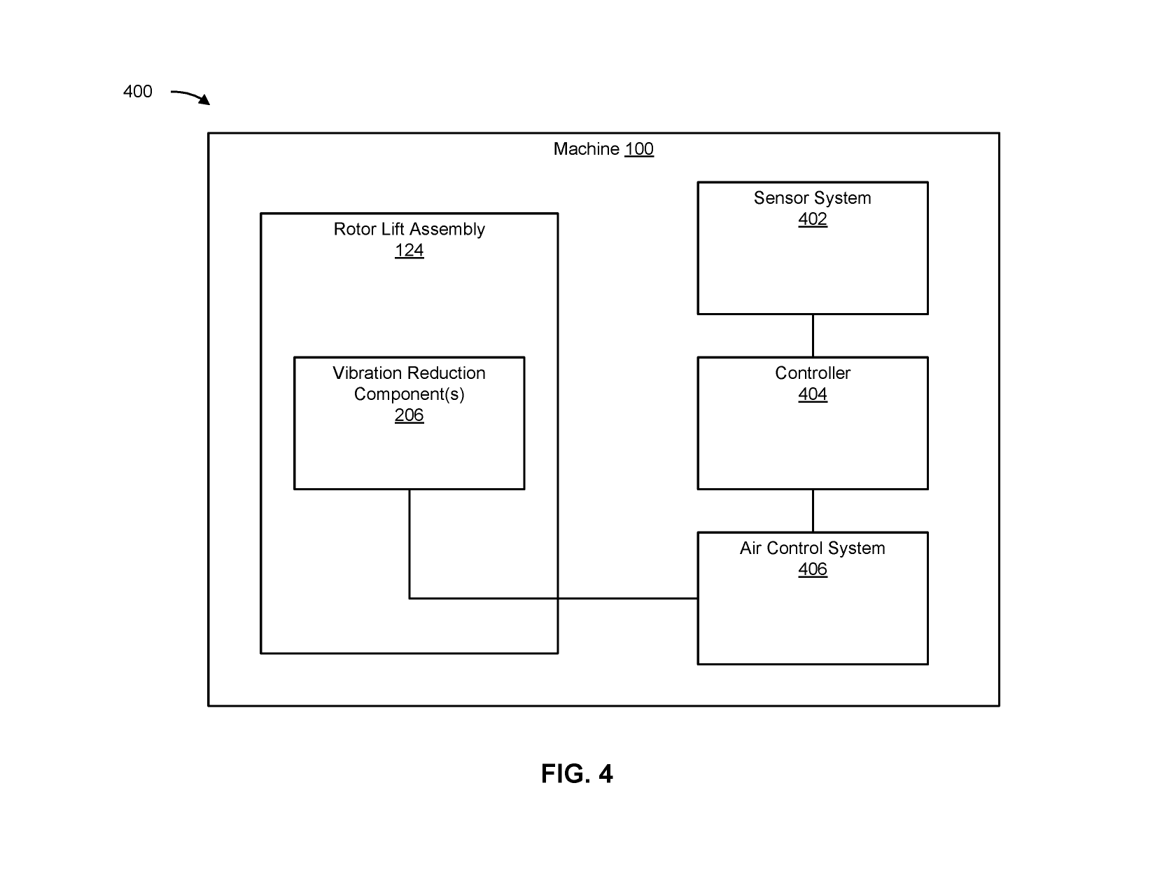

FIG. 4 shows an example 400 of the machine 100 described herein. As shown, in FIG. 4, the machine 100 includes the rotor lift assembly 124 and the one or more vibration reduction components 206, as described herein. The machine 100 may further include a sensor system 402, a controller 404, and/or an air control system 406.

The sensor system 402 may be configured to capture or determine vibration information associated with at least one of the machine 100 or the rotor lift assembly 124, which may indicate respective characteristics of vibrations experienced by the machine 100 or the rotor lift assembly 124 (e.g., at least one of an amplitude, a frequency, a waveform, or another characteristic of a vibration). The sensor system 402 may include, for example, an inertial sensor, a strain gauge, an acoustic sensor, or another type of sensor. The controller 404 may include an electronic control module (ECM), or another type of controller. The controller 404 may be communicatively connected to the sensor system 402 and the air control system 406, and may provide control of the air control system 406, as further described herein. The air control system 406 may be configured to regulate a respective air pressure of one or more components of the machine 100, such as a vibration reduction component 206 when the vibration reduction component 206 includes an airbag. The air control system 406 may include, for example, a compressor, a pressure regulator, a pressure relief valve, a pressure gauge, and/or a control valve.

In some implementations, the controller 404 may be configured to obtain vibration information (e.g., that is associated with at least one of the machine 100 or the rotor lift assembly 124), such as from the sensor system 402. For example, the sensor system 402 may send the vibration information (e.g., as the sensor system 402 collects or determines the vibration information) to the controller 404, such as via a connection between the controller 404 and the sensor system 402, which allows the controller 404 to receive the vibration information.

The controller 404 may determine (e.g., based on the vibration information) an air pressure setting for a particular vibration reduction component 206, of the one or more vibration reduction components 206, that includes an airbag. For example, the controller 404 may process the vibration information (e.g., using one or more processing techniques) to determine a severity classification for vibrations experienced by the machine 100 or the rotor lift assembly 124. The controller 404 may therefore determine an air pressure setting for the particular vibration reduction component that is associated with the severity classification (e.g., an air pressure setting to reduce propagation of the vibrations to, from, or within the rotor lift assembly 124).

Accordingly, the controller 404 may cause the air control system 406 to modify an air pressure of the particular vibration reduction component 206, in accordance with the air pressure setting. For example, the controller 404 may send one or more commands to the air control system 406, such as via a connection between the controller 404 and the air control system 406, which allows the controller 404 to receive the one or more commands. The one or more commands may indicate that the air control system 406 is to modify the air pressure of the particular vibration reduction component 206 (e.g., in accordance with the air pressure setting). This may thereby enable the air control system 406 (e.g., using one or more components of the air control system 406) to increase or decrease an amount of air within the particular vibration reduction component 206 (e.g., to cause the air pressure of the particular vibration reduction component 206 to be equal to, within a tolerance, an air pressure indicated by the air pressure setting).

In some implementations, the controller 404 may obtain other vibration information (e.g., that is associated with at least one of the machine 100 or the rotor lift assembly 124), such as from the sensor system 402 and after the controller 404 caused the air control system 406 to modify the air pressure of the particular vibration reduction component 206. The controller 404 may thereby determine another air pressure setting for the particular vibration reduction component 206, and may cause the air control system 406 to modify the air pressure of the particular vibration reduction component 206 in accordance with the other air pressure setting (e.g., in a similar manner as that described above). In this way, the controller 404 may cause the air pressure of the particular vibration reduction component 206 to change due to changing vibrations (e.g., that are associated with at least one of the machine 100 or the rotor lift assembly 124) that result from the machine 100 performing a milling operation.

As indicated above, FIG. 4 is provided as an example. Other examples may differ from what is described in connection with FIG. 4.

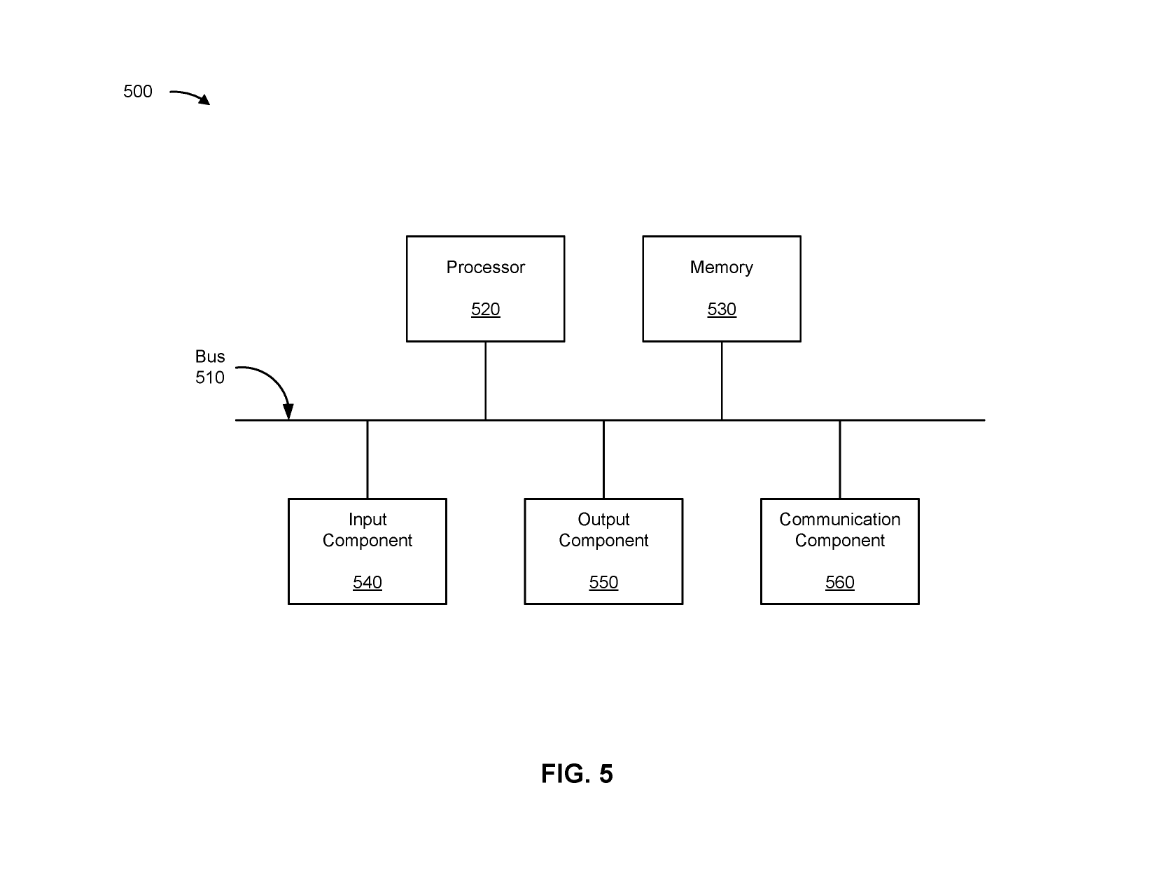

FIG. 5 is a diagram of example components of a device 500 associated with milling machine vibration reduction. The device 500 may correspond to may correspond to the sensor system 402, the controller 404, and/or the air control system 406. In some implementations, to the sensor system 402, the controller 404, and/or the air control system 406 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

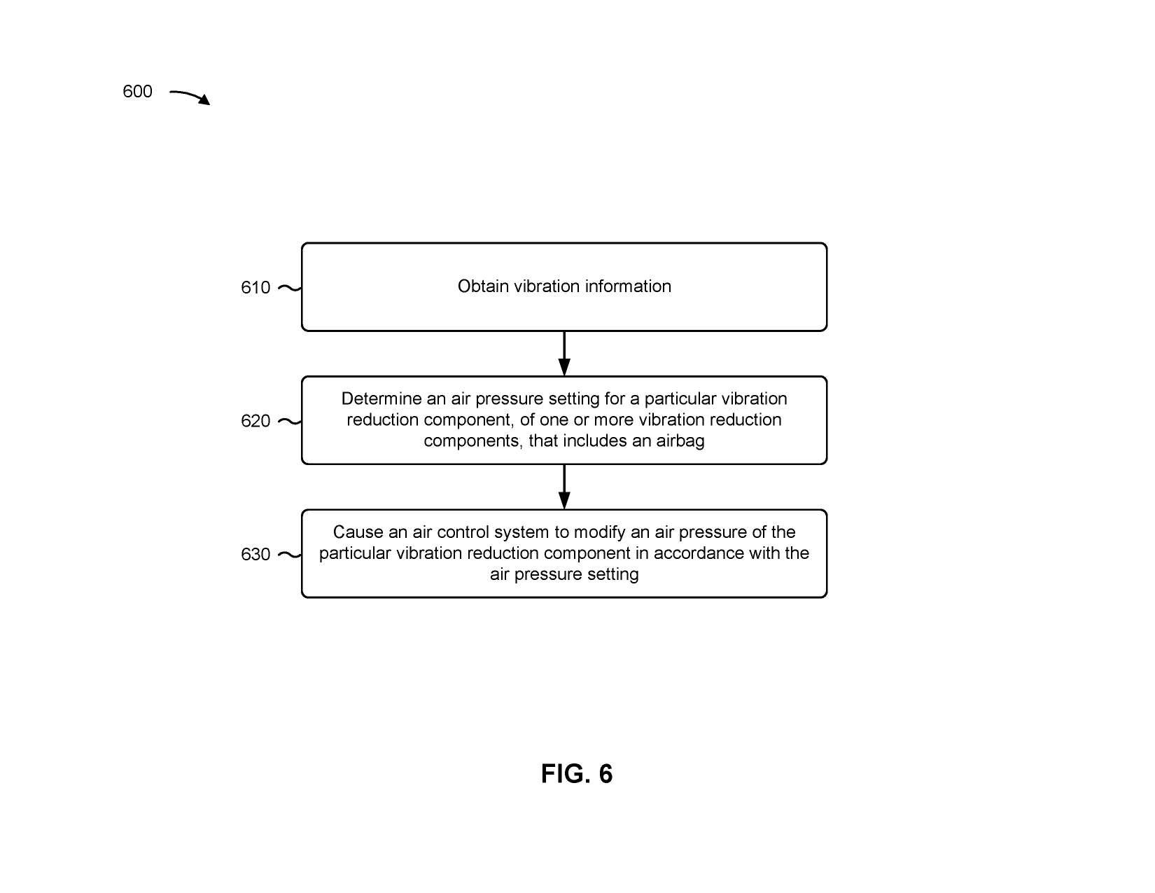

FIG. 6 is a flowchart of an example process 600 associated with milling machine vibration reduction. One or more process blocks of FIG. 6 may be performed by a controller (e.g., the controller 404) of a machine (e.g., the machine 100), such as a milling machine. Additionally, or alternatively, one or more process blocks of FIG. 4 may be performed by another device or a group of devices separate from or including the controller, such as another device or component that is internal or external to the machine.

As shown in FIG. 6, process 600 may include obtaining vibration information (block 610). For example, the controller may obtain vibration information (e.g., from a sensor system of the machine), as described above. The vibration information may be associated with at least one of the machine or a rotor lift assembly of the machine.

As shown in FIG. 6, process 600 may include determining an air pressure setting for a particular vibration reduction component, of one or more vibration reduction components, that includes an airbag (block 620). For example, the controller may determine (e.g., based on the vibration information) an air pressure setting for a particular vibration reduction component, of one or more vibration reduction components (e.g., of the rotor lift assembly of the machine), that includes an airbag, as described above.

As shown in FIG. 6, process 600 may include causing an air control system to modify an air pressure of the particular vibration reduction component in accordance with the air pressure setting (block 630). For example, the controller may cause an air control system (e.g., of the machine) to modify an air pressure of the particular vibration reduction component in accordance with the air pressure setting, as described above. Causing the air control system to modify the air pressure of the particular vibration reduction component enables the air control system to increase or decrease an amount of air within the particular vibration reduction component.

As further shown in FIG. 6, process 600 may include obtaining, from the sensor system, other vibration information associated with at least one of the machine or the rotor lift assembly; determining, based on the vibration information, another air pressure setting for the particular vibration reduction component; and causing the air control system to modify the air pressure of the particular vibration reduction component in accordance with the other air pressure setting.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

### INDUSTRIAL APPLICABILITY

The rotor lift assembly described herein can be used with any machine that performs a milling operation, such as by using a rotor. For example, the rotor lift assembly can be used with a machine that includes a first rotor lift arm, a second rotor lift arm, and a cross tube (e.g., that is connected to the first rotor lift arm and the second rotor lift arm), which are associated with the rotor.

A milling machine can include a rotor lift assembly that enables a rotor to be lowered (e.g., by actuators, which lower rotor lift arms of the rotor lift assembly) and thereby cut into and break up a surface of a paved area. Due to a hardness of the surface of the paved area and a rotational force at which the rotor engages the surface, vibrations are produced that can propagate to the rotor, the rotor lift assembly, and one or more other components of the milling machine. These vibrations can cause the rotor to deviate from an intended path, which impacts a milling performance of the rotor and the milling machine. Further, over time, excessive vibrations cause wear and tear on the rotor, the rotor lift assembly, and the one or more other components of the milling machine, which can lead to frequent required maintenance of the rotor, the rotor lift assembly, and the one or more other components of the milling machine and, in some cases, premature failure of the rotor, the rotor lift assembly, and the one or more other components of the milling machine.

In some implementations described herein, a rotor lift assembly of a machine (e.g., a milling machine) includes a first rotor lift arm, a second rotor lift arm, a cross tube, and one or more vibration reduction components. A first end of the cross tube is connected to the first rotor lift arm and a second end of the cross tube is connected to the second rotor lift arm. The one or more vibration reduction components are connected to the cross tube. In some implementations, the one or more vibration reduction components are disposed within an interior of the cross tube, such as in a configuration that is to provide a particular vibration reduction performance (e.g., in association with performance of a milling operation by the machine). Additionally, or alternatively, the first end of the cross tube is connected to the first rotor lift arm via a first set of one or more vibration reduction components, of the one or more vibration reduction components, and the second end of the cross tube is connected to the second rotor lift arm via a second set of one or more vibration reduction components of the one or more vibration reduction components. In this way, vibrations propagating from the cross tube to the first rotor lift arm and the second rotor lift arm and/or from the first rotor lift arm and the second rotor lift arm to the cross tube are reduced.

Thus, some implementations facilitate a milling machine vibration reduction. By having vibrations reduced, a rotor associated with the rotor lift assembly is less likely to deviate from an intended path, and therefore a milling performance of the rotor and the machine is improved. Further, by reducing vibrations, wear and tear on the rotor, the rotor lift assembly, and one or more other components of the machine are also reduced. This results in the machine needing less frequent maintenance, which enables the machine to remain operational for longer periods and to be more productive over an operable life of the machine. Further, less wear and tear decreases a likelihood of premature failure of the rotor, the rotor lift assembly, and the one or more other components of the milling machine, which enhances a performance consistency of the machine.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

WHAT IS CLAIMED IS:

1. A rotor lift assembly for a milling machine, comprising:
a first rotor lift arm;
a second rotor lift arm;
a cross tube; and
one or more vibration reduction components, wherein:
a first end of the cross tube is connected to the first rotor lift arm;
a second end of the cross tube is connected to the second rotor lift arm; and
the one or more vibration reduction components are connected to the cross tube.

2. The rotor lift assembly of claim 1, wherein the one or more vibration reduction components are disposed within an interior of the cross tube.

3. The rotor lift assembly of claim 2, wherein respective orientation axes of the one or more vibration reduction components are aligned.

4. The rotor lift assembly of claim 2, wherein an orientation axis of a first vibration reduction component, of the one or more vibration reduction components, is not aligned with an orientation axis of a second vibration reduction component of the one or more vibration reduction components.

5. The rotor lift assembly of claim 1, wherein:
the first end of the cross tube is connected to the first rotor lift arm via a first connection component of the rotor lift assembly;
a first vibration reduction component, of the one or more vibration reduction components, is connected to the first end of the cross tube and to the first rotor lift arm;
the second end of the cross tube is connected to the second rotor lift arm via a second connection component of the rotor lift assembly; and
a second vibration reduction component, of the one or more vibration reduction components, is connected to the second end of the cross tube and to the second rotor lift arm.

6. The rotor lift assembly of claim 1, wherein:
a first set of one or more vibration reduction components, of the one or more vibration reduction components, are connected to the first end of the cross tube and to the first rotor lift arm,
wherein the first end of the cross tube is connected to the first rotor lift arm via the first set of one or more vibration reduction components; and
a second set of one or more vibration reduction components, of the one or more vibration reduction components, are connected to the second end of the cross tube and to the second rotor lift arm,
wherein the second end of the cross tube is connected to the second rotor lift arm via the second set of one or more vibration reduction components.

7. The rotor lift assembly of claim 1, wherein each vibration reduction component, of the one or more vibration reduction components, comprises at least one of:
an isolation mount;
an airbag;
a hydraulic damper; or
a spring mount.

8. A milling machine, comprising:
a rotor lift assembly comprising:
a cross tube, and
one or more vibration reduction components, wherein:
a first end of the cross tube is connected to a first rotor lift arm of the rotor lift assembly;
a second end of the cross tube is connected to a second rotor lift arm of the rotor lift assembly; and
the one or more vibration reduction components are connected to the cross tube.

9. The milling machine of claim 8. , wherein the one or more vibration reduction components are disposed within an interior of the cross tube.

10. The milling machine of claim 9, wherein respective orientation axes of at least two of the one or more vibration reduction components are aligned.

11. The milling machine of claim 9, wherein respective orientation axes of at least two of the one or more vibration reduction components are not aligned.

12. The milling machine of claim 8., wherein:
a first vibration reduction component, of the one or more vibration reduction components, is connected to the first end of the cross tube and to the first rotor lift arm; and
a second vibration reduction component, of the one or more vibration reduction components, is connected to the second end of the cross tube and to the second rotor lift arm.

13. The milling machine of claim 8., wherein:
the first end of the cross tube is connected to the first rotor lift arm via a first set of one or more vibration reduction components of the one or more vibration reduction components; and
the second end of the cross tube is connected to the second rotor lift arm via a second set of one or more vibration reduction components of the one or more vibration reduction components.

14. The milling machine of claim 8., wherein each vibration reduction component, of the one or more vibration reduction components, comprises at least one of:
an isolation mount;
an airbag;
a hydraulic damper; or
a spring mount.

15. The milling machine of claim 8., further comprising:
a sensor system;
an air control system;
a controller, wherein the controller is configured to:
obtain, from the sensor system, vibration information associated with at least one of the milling machine or the rotor lift assembly;
determine, based on the vibration information, an air pressure setting for a particular vibration reduction component, of the one or more vibration reduction components, that includes an airbag; and
cause the air control system to modify an air pressure of the particular vibration reduction component in accordance with the air pressure setting.

16. The milling machine of claim 15, wherein causing the air control system to modify the air pressure of the particular vibration reduction component enables the air control system to increase or decrease an amount of air within the particular vibration reduction component.

17. The milling machine of claim 15, wherein the controller is further configured to:
obtain, from the sensor system, other vibration information associated with at least one of the milling machine or the rotor lift assembly;
determine, based on the vibration information, another air pressure setting for the particular vibration reduction component; and
cause the air control system to modify the air pressure of the particular vibration reduction component in accordance with the other air pressure setting.

18. A milling machine, comprising:
a cross tube of a rotor lift assembly of the milling machine; and
one or more vibration reduction components that are connected to the cross tube.

19. The milling machine of claim 18., wherein the one or more vibration reduction components are disposed within an interior of the cross tube.

20. The milling machine of claim 18., wherein:
a first end of the cross tube is connected to a first rotor lift arm via a first set of one or more vibration reduction components of the one or more vibration reduction components; and
a second end of the cross tube is connected to a second rotor lift arm via a second set of one or more vibration reduction components of the one or more vibration reduction components.
